(19) United States
(12) Patent Application Publication
(10) Pub. No.: US 2018/0275307 A1
(43) Pub. Date: Sep. 27, 2018

(54) Real-Time Determination Of Formation Water-Filled Porosity Using Dielectric Measurement Data

(71) Applicant: Halliburton Energy Services, Inc., Houston, TX (US)

(72) Inventors: Li Pan, Singapore (SG); Chao-Fu Wang, Singapore (SG); Greshan Kinsly, Singapore (SG); Aluth Durage Maleesh Prasan Rathnayaka, Singapore (SG)

(21) Appl. No.: 15/540,872

(22) PCT Filed: Sep. 17, 2015
(86) PCT No.: PCT/US2015/050704

§ 371 Date: Jun. 29, 2017

(51) Int. Cl. G01V 3/32; G01V 3/38

(52) U.S. Cl. CPC G01V 3/32; G01V 3/38

(57) ABSTRACT

A method for real-time determination of water-filled porosity of a formation using dielectric measurement data, whereby the refractive index of a non-water component of the formation and the downhole temperature are acquired, along with the dielectric constant of the formation. Using these values, the water salinity of the formation is calculated. Calculation of the water salinity involves the use of a complex nonlinear equation having multiple solutions. A theorem is applied to the nonlinear equation which produces a single proper solution. Once the water salinity is calculated, it is then used to calculate the water-filled porosity of the formation.

### FIELD OF THE DISCLOSURE

Embodiments of present disclosure generally relate to downhole logging and, more particularly, to a method for the real-time determination of water salinity and water-filled porosity of a formation using dielectric measurement data.

### BACKGROUND

Oilfield operators demand access to a great quantity of information regarding the conditions encountered downhole. Such information typically includes characteristics of the earth formations traversed by the borehole and data relating to the size and configuration of the borehole itself. The collection of information relating to conditions downhole, which commonly is referred to as “logging,” can be performed by several methods, including wireline logging.

In wireline logging, a probe or “sonde” is lowered into the borehole after some or the entire well has been drilled. The sonde hangs at the end of a long cable (“wireline”) that provides mechanical support to the sonde and also provides an electrical connection between the sonde and electrical equipment located at the surface of the well. In accordance with existing logging techniques, various parameters of the earth's formations are measured and correlated with the position of the sonde in the borehole as the sonde is pulled uphole. The direct electrical connection between the surface and the sonde provides power and a relatively large bandwidth for conveying logging information.

One desirable formation parameter is water-filled porosity of the formation, as it is useful for determining the quantity and producibility of hydrocarbons within the formation. As the name implies, water-filled porosity describes the proportion of water present in the formation. To obtain the water-filled porosity, knowledge regarding water salinity is usually required. The standard techniques for determining water salinity are: (1) take a water sample from the well after it has been drilled, or (2) extrapolate from other wells in the region.

Experience has shown these approaches to be unreliable due to significant salinity variation within and between wells, particularly when fluid injection is employed for secondary recovery. In the latter case, the fluid injection causes substantial salinity variation laterally across the reservoir and vertically around the reservoir, making the standard techniques impractical or hopelessly inaccurate. In either case, a determination of water salinity in real time is not feasible, thus requiring additional time and money for analysis. Absent an accurate measure of water salinity, the consequent determinations of water-filled porosity and corresponding implications regarding hydrocarbons are unreliable.

### BRIEF DESCRIPTION OF THE DRAWINGS

FIG. 1 shows a wireline logging assembly according to an illustrative embodiment of the present disclosure;

FIG. 2 is a flow chart of a method for determining water-filled porosity, according to certain illustrative methods of the present disclosure;

FIG. 3 is a flow chart of an method for calculating water salinity at block 208 of FIG. 2, according to certain illustrative methods of the present disclosure; and

FIG. 4 illustrates a series of logs showing application of the method of FIG. 3 to actual dielectric logging data.

### DESCRIPTION OF ILLUSTRATIVE EMBODIMENTS

Illustrative embodiments and related methods of the present disclosure are described below as they might be employed in a method for determining water salinity and water-filled porosity of a formation using dielectric measurement data. In the interest of clarity, not all features of an actual implementation or method are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methods of the disclosure will become apparent from consideration of the following description and drawings.

As described herein, illustrative methods of the present disclosure are directed to methods for real-time calculation of water salinity and water-filled porosity of a formation using dielectric measurement data. In a generalized method, the refractive index of a non-water component of the formation and the downhole temperature are acquired, along with the dielectric constant of the formation. Using these values, the water salinity of the formation is calculated. Calculation of the water salinity involves the use of a complex nonlinear equation having multiple solutions. A theorem is applied to the nonlinear equation which produces a single proper solution. Once the water salinity is calculated, it is then used to calculate the water-filled porosity of the formation.

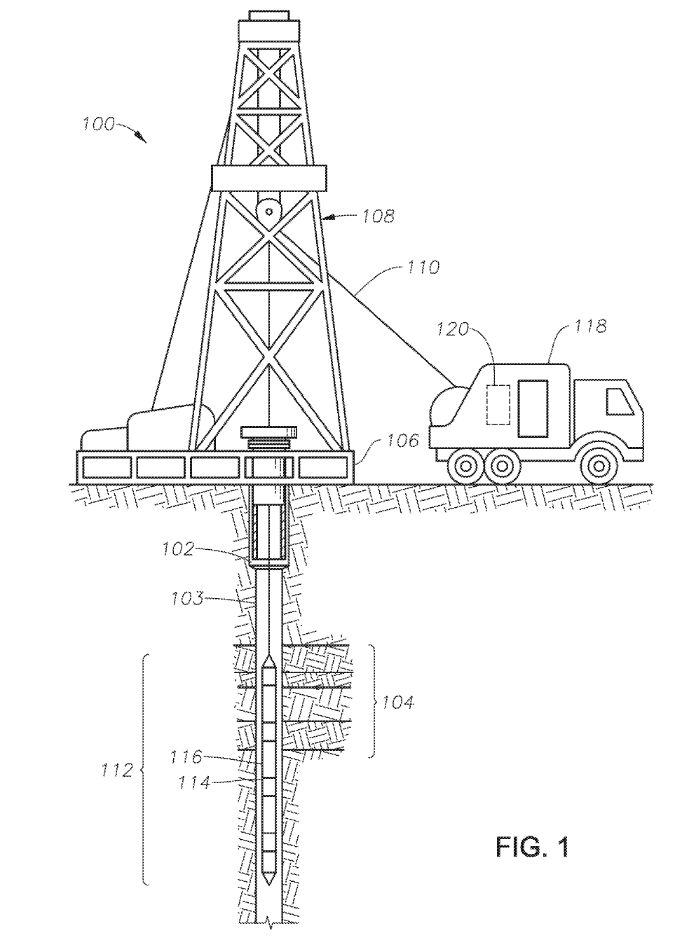

FIG. 1 shows a wireline logging environment 100 in which the illustrative methods of the present disclosure may be practiced. In FIG. 1, a wellbore/borehole 102 (having a borehole wall 103) has been drilled through various formations 104 in a typical drilling manner. A drilling platform 106 supports a derrick 108 capable of raising and lowering a drill string (not shown) through borehole 102. In the figure, the drill string has been removed, enabling a wireline cable 110 to convey a wireline tool string 112 through borehole 102. As depicted, tool string 112 includes various downhole tools 114, 116 that may help with a determination of formation properties, for example, water salinity and water-filled porosity determinations, as described herein. Although a wireline-type assembly is illustrated, the methods described herein may be used in other downhole assemblies, such as, for example, a logging-while-drilling (“LWD”) or measurement-while-drilling (“MWD”) assembly.

In certain illustrative embodiments, downhole tools 114, 116 may include, for example, a density-neutron or nuclear magnetic resonance (“NMR”) tool to acquire refractive index measurements, along with a dielectric measurement tool, such as, for example, a LOGIQ® High-Frequency Dielectric Tool offered by Halliburton Energy Services, Co of Houston, Tex., the Assignee of the present disclosure. However, it will be appreciated that additional tools may be included on tool string 112, such as, for example, a control sub for coordinating the operation of the various tools in the tool string and providing telemetry that enables the measurements collected by the various tools to be communicated to the surface. Alternatively, or in addition to being communicated to the surface, measurements collected by tools 114, 116 may be stored in memory of tool string 112 and/or processed by a downhole processor within tool string 112.

A computing or logging facility 118 which includes a computer system 120 having a processor (i.e., processing circuitry) may be arranged at the surface to receive the processed or unprocessed measurements. In alternative embodiments, the processing circuitry may be positioned downhole. The computer system 120 may include a memory having software executed by the processor to configure logging facility 118 to manage tool string 112 operations, acquire and store the measurements, and process the measurements for display to an operator. For example, computer system 120 and processor may be capable of receiving the downhole measurements from tools 114, 116, and responsively calculating/determining water salinity and/or water-filled porosity of the formation. Moreover, such calculations may be a function of the acquired temperature, dielectric, and porosity measurements from tools 114, 116. In particular, the water-filled porosity calculations may be based at least in part on water salinity and down hole temperature. The memory of computer system 120 may additionally store information for recall later, such as the water salinity, dielectric constants, and water-filled porosity. Additionally, logging facility 118 may present the raw or calculated information to a user via a user interface that includes a monitor or printer.

While wireline environment 100 of FIG. 1 is depicted as a land-based environment with a vertical wellbore 16, it is contemplated herein that the same principles may be applied to a sea-based environment, as well as a deviated or horizontal wellbore, without departing from the scope of the disclosure.

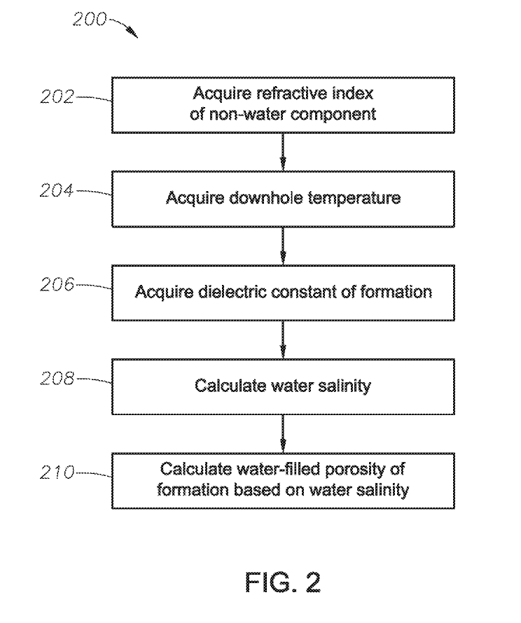

FIG. 2 is a flow chart of a method 200 for determining water-filled porosity, according to certain illustrative methods of the present disclosure. The method 200 may be implemented by a computer system having a program stored on a non-transient computer program product and executed by a processor to determine the water-filled porosity, such as the computer system 120 described above. For the calculations described herein, method 200 will adhere to the notations listed in Table 1 below.

TABLE 1
Notations Used in Method 200.

| Notation | Physical Meaning | Unit |
|---|---|---|
| ϵ₀ | Vacuum permittivity | F/m |
| | ϵ ≈ 8.854187817 · 10⁻¹² | (farad per |
| | | meter) |
| ϵₘₑₐ^{*} | Measured complex dielectric constant of formation. | |
| ϵ_{nw}^{*} | Complex dielectric constant of non-water | |
| ϵ_{w}^{*} | Complex dielectric constant of water. | |
| | ${ϵ}_{w}^{*} = {ϵ}_{w}^{′} + i \cdot {ϵ}_{w}^{″} = {ϵ}_{w}^{′} + i \cdot \frac{{σ}_{w}}{{ωϵ}_{0}} = {ϵ}_{w}^{′} + i \cdot \frac{1}{{ωϵ}_{0} {R}_{w}}$ | |
| ϕ_{w} | Water-filled porosity | |
| f | Operating frequency | Hz |
| R_{w} | Water resistivity | Ω · m |
| T_{mud} or T | Temperature of mud filtrate | ° F. |
| | | (Fahren- |
| | | heit |
| | | Degree) |
| ω | Angular frequency | Rad/s |
| | ω = 2πf | |
| X | Salinity | KPPM |
| | | (thousand |
| | | parts per |
| | | million) |
| X₁ | The first solution of salinity | KPPM |
| | | (thousand |
| | | parts per |
| | | million) |
| X₂ | The second solution of salinity | KPPM |
| | | (thousand |
| | | parts per |
| | | million) |
| X_{low} | Lower bound of the salinity region | KPPM |
| | | (thousand |
| | | parts per |
| | | million) |
| Xᵤₚ | Upper bound of the salinity region | KPPM |
| | | (thousand |
| | | parts per |
| | | million) |
| Xₘ | Medium of the salinity values within the | KPPM |
| | preceding 3″ range | (thousand |
| | | parts per |
| | | million) |
| ζ_{mea*} | refractive index of formation with the assumption | |
| | that permeability equals 1 | |
| | ${ζ}_{mea}^{*} = {( {ϵ}_{mea}^{*} )}^{\frac{1}{2}}$ ${ζ}_{mea}^{*} = {ζ}_{mea}^{′} + i \cdot {ζ}_{mea}^{″}$ | |
| ζ_{nw*} | refractive index of non-water material with the | |
| | assumption that permeability equals 1 | |
| | ${ζ}_{nw}^{*} = {( {ϵ}_{nw}^{*} )}^{\frac{1}{2}}$ $ζ = {ζ}_{nw}^{′} + i \cdot {ζ}_{nw}^{″}$ | |
| ζ_{w*} | refractive index of water with the assumption that | |
| | permeability equals 1 | |
| | ${ζ}_{w}^{*} = {( {ϵ}_{w}^{*} )}^{\frac{1}{2}}$ ${ζ}_{w}^{*} = {ζ}_{w}^{′} + i \cdot {ζ}_{w}^{″}$ | |

With reference to FIGS. 1 and 2, in general, to determine water-filled porosity, ϕ_{w}, tools 114,116 (e.g., an NMR tool) acquires measurements corresponding to the refractive index of the non-water component of the formation, ζ_{nw}*, at block 202. Tools 114,116 then communicate signals indicative of the refractive index to computer system 120. At block 204, the downhole temperature, T, of wellbore 102 is acquired using tools 114,116 (e.g., temperature tool). Signals indicative of the temperature measurement are then communicated to computer system 120. At block 206, a high-frequency dielectric tool (operating at 1 GHz, for example) embodied as one of tools 114,116 acquires, in real-time, the dielectric constant of the formation, ∈ₘₑₐ*, and communicates signals indicative of the measurements to computer system 120. Note, in certain illustrative methods, different tools may be utilized to acquire the refractive index, downhole temperature, and dielectric constant, and the corresponding signals communicated to computer system 120 accordingly. For example, a first logging tool 114 (e.g., density-neutron or NMR tool) may be used to acquire the refractive index, while the temperature and dielectric constant are acquired using a second logging tool 116 (e.g., high-frequency dielectric logging tool). In alternate embodiments, the tools 114,116 may communicate raw data used by computer system 120 to calculate the refractive index, temperature and dielectric constant.

At block 208, using the following equations, the processor calculates the water salinity of the formation based upon, in part, the refractive index, temperature, and dielectric constant measurements. In general, the following nomenclature is used throughout the equations: variables having an “*” are a complex value having real and imaginary components. Variables having a single apostrophe (′) are the real components of the complex value, while variables having a double apostrophe (″) are the imaginary components of the complex value.

The Stroud, Milton and De (“SMD”) model (1986) for the dielectric constant of brine water, (∈_{w}*=∈_{w}′+∈_{w}″), is given in Equations 1 and 2 below, where the water diffusion loss term is added to better describe the asymptotic behavior of ∈_{w}″ at low salinities and temperatures. In this example, SMD is used to calculate ∈_{w}* and therefore ζ_{w}* which are needed in Equation 7 below.

$$\begin{matrix}{ϵ}_{w}^{′} ( T , X ) = {[ \frac{1}{{ϵ}_{w}^{′} ( T , 0 )} + \frac{2.4372 X}{58.443 \cdot ( 1000 - X )} ]}^{- 1} & ( 1 ) \\ {ϵ}_{w}^{″} ( T , X ) = 17.9753 \cdot {σ}_{w} ( T , X ) + {ϵ}_{dl} ( T ) & ( 2 )\end{matrix}$$

where,

$$\begin{matrix} {ϵ}_{w}^{′} ( T , 0 ) = 94.88 - 0.2317 \cdot T + 0.000217 \cdot {T}^{2} & ( 3 ) \\ {σ}_{w} ( T , X ) = {\frac{T + 7}{82} [ 0.0123 + \frac{3647.5}{{( 1000 \cdot X )}^{0.955}} ]}^{- 1} & ( 4 ) \\ {ϵ}_{dl} ( T , f = 1 GHz ) = 1.727 \cdot {10}^{- 5} \cdot 1 \cdot \frac{78.945 \cdot {C ( T )}^{2} - 1.771 \cdot {C ( T )}^{0.122}}{1 + {( \frac{1}{19.6} )}^{2}} \cdot {2.718}^{\frac{4273}{T + 460}} , & \end{matrix}$$

where e_{dl} represents dielectric loss.

C(T)=1−3.862·10⁻⁷(T−75)(3175−T) (5A and 5B).

The refractive index of a matter equals \sqrt{∈ᵣμᵣ}, since the permeability of matters associated with borehole studies is μᵣ=1, the refractive index of the methods described herein is defined as:

ζ_{w}*=ζ_{w}′+i·ζ_{w}″=\sqrt{∈_{w}*} (6)

where

$${ζ}_{w}^{′} = Real ( {ζ}_{w}^{*} ) = \sqrt[4]{{ϵ}_{w}^{{′}^{2}} + {ϵ}_{w}^{{″}^{2}} } \cdot cos ( \frac{α}{2} )$$

$${ζ}_{w}^{″} = Imag ( {ζ}_{w}^{*} ) = \sqrt[4]{{ϵ}_{w}^{{′}^{2}} + {ϵ}_{w}^{{″}^{2}} } \cdot sin ( \frac{α}{2} )$$

$$α = arctan ( \frac{{ϵ}_{w}^{″}}{{ϵ}_{w}^{′}} ) .$$

The Complex Refractive Index Model (Ellis and Singer 2007) (“CRIM”) gives the complex refractive index of the formation as a function of water-filled porosity, complex refractive index of water, and complex refractive index of the non-water component, as shown in Equation 7.

ζₘₑₐ*=ϕ_{w}ζ_{w}*+(1−ϕ_{w})ζ_{nw}* (7)

Equation 7 can then be split into the real part and imaginary part, as in Equation 8.

ζₘₑₐ′+i·ζₘₑₐ″=ϕ_{w}(ζ_{w}′+i·ζ_{w}″)+(1−ϕ_{w})(ζ_{nw}′+i·ζ_{nw}″) (8)

### In Equation 8,

ζₘₑₐ′=ϕ_{w}ζ_{w}′+(1−ϕ_{w})ζ_{nw}′ (1)

ζₘₑₐ″=ϕ_{w}ζ_{w}″+(1−ϕ_{w})ζ_{nw}″ (10)

Still referencing block 208, to evaluate water salinity, Equation 11 is derived from CRIM Equations 9 and 10.

$$\frac{{ζ}_{mea}^{′} - {ζ}_{nw}^{′}}{{ζ}_{mea}^{″} - {ζ}_{nw}^{″}} = \frac{{ζ}_{w}^{′} - {ζ}_{nw}^{′}}{{ζ}_{w}^{″} - {ζ}_{nw}^{″}} \qquad ( 11 )$$

To simplify the following derivation, we define M, an auxiliary parameter defined for convenience, as:

$$\begin{matrix}M = \frac{{ζ}_{mea}^{′} - {ζ}_{nw}^{′}}{{ζ}_{mea}^{″} - {ζ}_{nw}^{″}} \\ {f}_{1} ( T , X ) = {ζ}_{w}^{′} \\ {f}_{2} ( T , X ) = {ζ}_{w}^{″}\end{matrix}$$

Substitution of these new definitions into Equation 11 yields:

$$\frac{{f}_{1} - {ζ}_{nw}^{′}}{{f}_{2} - {ζ}_{nw}^{″}} = M$$

which can be further rearranged to be (12):

F(X)=f₁−Mf₂+Mζ_{nw}″−ζ_{nw}′=0 (12)

Since the complex dielectric constant of the formation is measured by the tools 114,116 (e.g., high frequency dielectric tool), indexes ζₘₑₐ′ and ζₘₑₐ″ are known. In practice, indexes ζ_{nw}′ and ζ_{nw}″ are known or estimable from previously obtained or calculated data. The borehole temperature, T, is measured by tools 114,116, as previously described, and communicated to the computer system 120 for processing. Therefore, (12) becomes a complex nonlinear equation with multiple solutions of unknown variable X, the water salinity. The solution of Equation 12 will be further discussed below. Once water salinity is calculated by the processor, at block 210, water-filled porosity (ϕ_{w}) can be solved from (1 above as:

$${φ}_{w} ( X ) = \frac{{ζ}_{mea}^{′} - {ζ}_{nw}^{′}}{{ζ}_{w}^{′} ( X ) - {ζ}_{nw}^{′}} \qquad ( 2 )$$

In Equation 13, the relative error

$$\frac{\vert {X}_{cal} - {X}_{actual} \vert}{{X}_{actual}} \cdot 100 \%$$

is always lower than 1%.

The solution to Equation 12 will now be discussed in more detail. Since Equation 12 is a complex nonlinear equation with multiple solutions, it would be computationally expensive and time-consuming to calculate all its solutions and then select the proper answer from them. In addition, the case is often encountered where ordinary methods fail to converge. Accordingly, in certain illustrative methods of the present disclosure, to find the proper solution to Equation 12, the following theorem is applied which can be proved readily by numerical simulation or analytical methods:
Theorem: For 0≤T≤210 (° F.), 0≤ϕ_{w}≤1, 0≤X≤300 (KPPM), the following two facts hold for Equation 12: (a) F(300) and F(0) take opposite signs (“+” & “−”); and (b) there exists only one solution for Equation 12.

It is note-worthy that, in this illustrative Theorem, the assumed range of water salinity q, (0-300,000 parts per million) suffices the requirements in all practical logging situations; the assumed range of porosity (0-1) covers all possible situations. The range of temperature (0-210° F.) is normally enough for most practical application, as shown in various test case logging data from the Rockies, Baker field, and Pennsylvania, where the formation temperature always ranges from 80 to 160 F °.

Furthermore, the Theorem indicates that a unique solution is guaranteed within the reasonable water salinity region, and Equation 12 takes opposite signs at the upper and lower bounds. These two properties of Equation 12 suggest using a bisection method to solve the equation in the range of (0, 300 KPPM), for three reasons: (1) The convergence of the bisection method is guaranteed by the two facts; (2) the computational cost is low since no gradient calculation is required; and (3) good precision of results is guaranteed, since it takes only 8 steps of iteration to achieve the precision of 1 KPPM, and 11 steps to the precision of 0.1 KPPM.

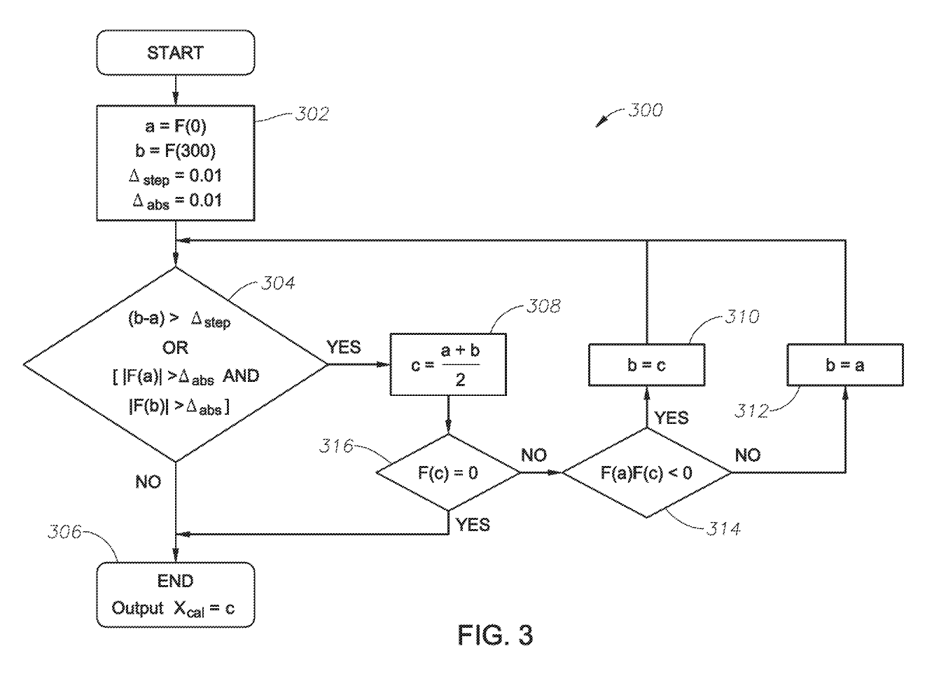

FIG. 3 is a flow chart of a method 300 for calculating water salinity at block 208, according to an illustrative method of the present disclosure. At block 302, the method defines a=F(0), which is Equation 12 with “a” being an auxiliary parameter; b=F(300), again applying Equation 12 with b being the auxiliary parameter; Δstep=0.01, where the convergence criteria wants the distance between a and b to be smaller than Δstep; and Δabs=0.01, where the convergence criteria wants the final value of |F(a)| and |F(b)| to be smaller than Δabs. At block 304, if one of the two conditions are not met, the method advances to block 306, where it ends by outputting the water salinity Xcal=c. However, if one of the two conditions are met at block 304, the method advances to block 308 where the value of c is calculated, and the method advances to block 316. At block 316, if F(c)=0, the water salinity is output at block 306. However, if F(c) does not equal 0, the method advances to block 314, where another condition (F(a)F(c)<0) must be met. If this condition is met, the method advances to block 310 where the processor sets b=c and block 304 is performed again. If the condition of block 314 is not met, the method advances to block 312, where the processor sets b=a and block 304 is performed again. This method is performed by the processor in an iterative fashion, until the water salinity is calculated at block 208.

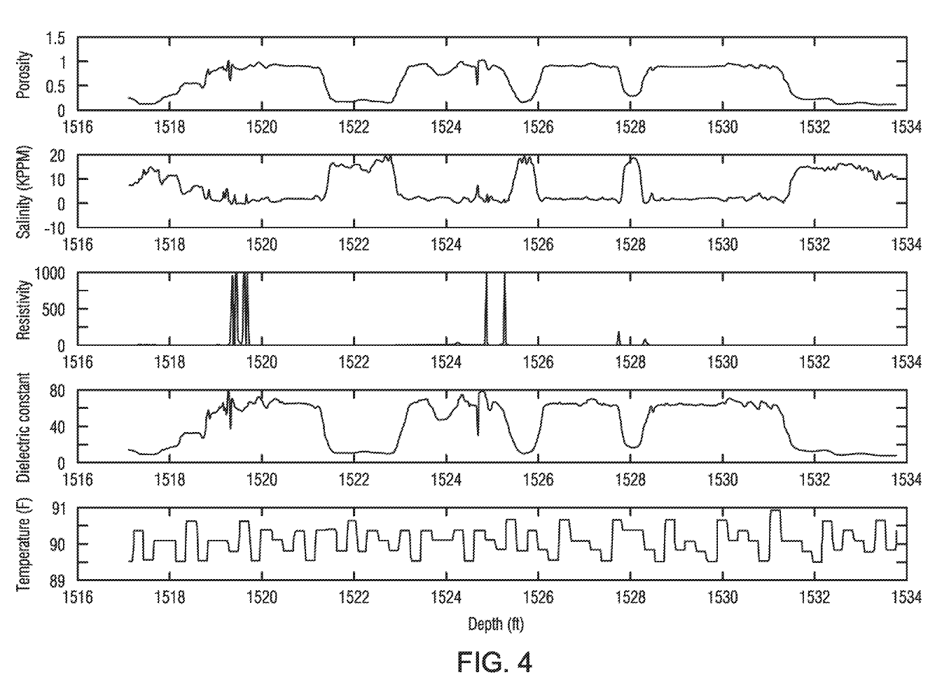

Method 300 can be readily integrated with the INSITE® data system, produced by Halliburton Energy Services, Co., or a similar fashioned platform. Method 300 has been applied to real dielectric logging data, the results being shown in FIG. 4. Here, logs showing the temperature, dielectric constant, resistivity, water salinity and porosity are illustrated per measured depth of the wellbore. According to the illustrative test, the result of each logging sample can be obtained in less than 0.01 seconds on a laptop with, for example, an Intel® Core™ i7-2620M CPU @ 2.70 GHz and 8.00 GB RAM. Hence, method 300 fulfills the real-time operation requirement in that the results for each logging sample were generated in less than 0.02 seconds.

The illustrative methods described herein provide a number of advantages. As compared with existing methods of evaluating water salinity, which take water samples from the well or extrapolates from the water sample from other wells, this disclosure provides robust and effective methods for the real-time and accurate evaluation of water salinity and, thus, water-filled porosity. In addition, the disclosed methods of determining water salinity do not require prior knowledge of the range of water salinity because the salinity region the sample will fall into is known before taking the measurement though use of Equation 12. Table 2 below shows three sample regions of salinity. Acquiring such information is particularly inconvenient when the water salinity for the same well varies from one region to another region vertically.

TABLE 2
Three regions of salinity.

| # | Corresponding Water Component | Salinity |
|---|---|---|
| Region 1 | Fresh/Brackish water | (0.1, 12) |
| Region 2 | Salty water | (12, 80) |
| Region 3 | Brine water | (80, 300) |

Moreover, the disclosed methods provide accurate and unique solutions of the water salinity of the formation. Furthermore, the solution obtained by the disclosed methods is naturally solved from governing equations without using any polynomial approximation of SMD model.

Embodiments described herein further relate to any one or more of the following paragraphs:

1. A method for determining water-filled porosity of a formation, the method comprising acquiring a refractive index of a non-water component of the formation; acquiring a temperature of a wellbore extending along the formation; acquiring a dielectric constant of the formation; calculating water salinity of the formation based upon the refractive index, temperature and dielectric constant; and calculating water-filled porosity of the formation based upon the water salinity.

2. A method as defined in paragraph 1, wherein calculating the water salinity comprises solving a complex nonlinear equation having multiple solutions for the water salinity.

3. A method as defined in paragraphs 1 or 2, further comprising applying a theorem to the complex nonlinear equation wherein the water salinity is assumed to be in a range between 0 and 300,000 parts per million.

4. A method as defined in any of paragraphs 1-3, wherein the theorem further assumes the water-filled porosity to be in a range between 0 and 1.

5. A method as defined in any of paragraphs 1-4, wherein the method is performed in real-time.

6. A method as defined in any of paragraphs 1-5, wherein the method is performed using a downhole assembly comprising one or more logging tools.

7. A method as defined in any of paragraphs 1-6, wherein the downhole assembly is a wireline or logging-while-drilling assembly.

8. A method as defined in any of paragraphs 1-7, wherein the refractive index is acquired using a first logging tool; and the temperature and dielectric constant are acquired using a second logging tool.

9. A method as defined in any of paragraphs 1-8, wherein the first logging tool is a density-neutron or nuclear magnetic resonance tool.

10. A method as defined in any of paragraphs 1-9, wherein the second logging tool is a High Frequency Dielectric Tool operating at a frequency of 1 GHz.

11. A method as defined in any of paragraphs 1-10, wherein prior knowledge of water salinity is not required to determine the water salinity of the formation.

12. A method for determining water-filled porosity of a formation, the method comprising acquiring water-filled porosity of the formation using dielectric measurement data.

13. A method as defined in paragraph 12, wherein the water-filled porosity comprises solving a complex nonlinear equation having multiple solutions for water salinity.

14. A method as defined in paragraphs 12 or 13, further comprising applying a theorem to the complex nonlinear equation wherein the water salinity is assumed to be within a range.

15. A method as defined in any of paragraphs 12-14, wherein the range is between 0 and 300,000 parts per million.

16. A method as defined in any of paragraphs 12-15, wherein the theorem further assumes the water-filled porosity to be in a range.

17. A method as defined in any of paragraphs 12-16, wherein the range is between 0 and 1.

18. A method as defined in any of paragraphs 12-17, wherein the method is performed in real-time.

19. A method as defined in any of paragraphs 12-18, wherein the method is performed to using a downhole assembly; and the dielectric measurement data is acquired by the downhole assembly.

20. A method as defined in any of paragraphs 12-19, wherein the dielectric measurement data is acquired by a tool operating at 1 GHz.

21. A system for determining water-filled porosity of a formation, the system comprising a downhole tool to acquire one or more measurements related to water-filled porosity; and processing circuitry coupled to the downhole tool to receive one or more signals indicative of the measurements and thereby implement any of the methods of paragraphs 1-20.

22. A computer program product comprising instructions which, when executed by at least one processor, causes the processor to receive one or more signals indicative of one or more measurements related to water-filled porosity, the measurements being acquired by a downhole tool; and perform any of the methods of paragraphs 1-20 using the signals.

Furthermore, the illustrative methodologies described herein may be implemented by a system comprising processing circuitry or a computer program product comprising instructions which, when executed by at least one processor, causes the processor to perform any of the methodology described herein.

Although various embodiments and methodologies have been shown and described, the disclosure is not limited to such embodiments and methodologies and will be understood to include all modifications and variations as would be apparent to one skilled in the art. Therefore, it should be understood that the disclosure is not intended to be limited to the particular forms disclosed. Rather, the intention is to cover all modifications, equivalents and alternatives falling within the spirit and scope of the disclosure as defined by the appended claims.

1. A method for determining water-filled porosity of a formation, the method comprising:
acquiring a refractive index of a non-water component of the formation;
acquiring a temperature of a wellbore extending along the formation;
acquiring a dielectric constant of the formation;
calculating water salinity of the formation based upon the refractive index, temperature and dielectric constant; and
calculating water-filled porosity of the formation based upon the water salinity.

2. A method as defined in claim 1, wherein calculating the water salinity comprises solving a complex nonlinear equation having multiple solutions for the water salinity.

3. A method as defined in claim 2, further comprising applying a theorem to the complex nonlinear equation wherein the water salinity is assumed to be in a range between 0 and 300,000 parts per million.

4. A method as defined in claim 3, wherein the theorem further assumes the water-filled porosity to be in a range between 0 and 1.

5. A method as defined in claim 1, wherein the method is performed in real-time.

6. A method as defined in claim 1, wherein the method is performed using a downhole assembly comprising one or more logging tools.

7. A method as defined in claim 6, wherein the downhole assembly is a wireline or logging-while-drilling assembly.

8. A method as defined in claim 6, wherein:
the refractive index is acquired using a first logging tool; and
the temperature and dielectric constant are acquired using a second logging tool.

9. A method as defined in claim 8, wherein the first logging tool is a density-neutron or nuclear magnetic resonance tool.

10. A method as defined in claim 9, wherein the second logging tool is a High Frequency Dielectric Tool operating at a frequency of 1 GHz.

11. A method as defined in claim 1, wherein prior knowledge of water salinity is not required to determine the water salinity of the formation.

12. A method for determining water-filled porosity of a formation, the method comprising acquiring water-filled porosity of the formation using dielectric measurement data.

13. A method as defined in claim 12, wherein the water-filled porosity comprises solving a complex nonlinear equation having multiple solutions for water salinity.

14. A method as defined in claim 13, further comprising applying a theorem to the complex nonlinear equation wherein the water salinity is assumed to be within a range.

15. A method as defined in claim 14, wherein the range is between 0 and 300,000 parts per million.

16. A method as defined in claim 14, wherein the theorem further assumes the water-filled porosity to be in a range.

17. A method as defined in claim 16, wherein the range is between 0 and 1.

18. A method as defined in claim 12, wherein the method is performed in real-time.

19. A method as defined in claim 18, wherein:
the method is performed using a downhole assembly; and
the dielectric measurement data is acquired by the downhole assembly.

20. A method as defined in claim 12, wherein the dielectric measurement data is acquired by a tool operating at 1 GHz.

21. A system for determining water-filled porosity of a formation, the system comprising:
a downhole tool to acquire one or more measurements related to water-filled porosity; and
processing circuitry coupled to the downhole tool to receive one or more signals indicative of the measurements and thereby implement the method of claim 20.

22. A computer program product comprising instructions which, when executed by at least one processor, causes the processor to:
receive one or more signals indicative of one or more measurements related to water-filled porosity, the measurements being acquired by a downhole tool; and
perform the method of claim 20.
